(19) United States
(12) Patent Application Publication
(10) Pub. No.: US 2026/0210461 A1
(43) Pub. Date: Jul. 23, 2026

(54) Fitting and Thread Seal for Establishing a Fluid-Tight Screw Connection for a Pipe with an External Thread

(71) Applicant: Viega Technology GmbH & Co. KG, Attendorn (DE)

(72) Inventors: Philipp Dasbach, Wilnsdorf (DE); David Lindemann, Gummersbach (DE)

(21) Appl. No.: 19/421,289

(22) Filed: Dec. 16, 2025

(30) Foreign Application Priority Data
Dec. 20, 2024 (DE) 10 2024 139 196.0

(51) Int. Cl. F16L 19/04

(52) U.S. Cl. CPC F16L 19/041; F16L 2201/10

(57) ABSTRACT

The invention relates to a fitting for establishing a fluid-tight screw connection for a pipe (6) having an external thread (4), with a fitting base body (8), with a press sleeve (10) connected to the fitting base body (8), with a chamber (12) formed in the press sleeve (10), with a thread seal (14) arranged in the chamber (12) and having an internal thread (16), with a first marking (18, 18′) arranged on the press sleeve (10) and with a second marking (20, 20′) arranged on the thread seal (14), wherein the markings (18, 18′; 20, 20′) can be aligned relative to each other by rotation based on the same central axis of the internal thread (16) of the thread seal (14) and of the press sleeve (10). The object to provide a fitting and a thread seal for a fitting for establishing a fluid-tight screw connection for a pipe having an external thread and a fitting itself, in which the disadvantages known from the prior art do not occur or at least occur to a lesser extent, is solved.

### CROSS-REFERENCE TO RELATED APPLICATIONS

This application claims priority to German Patent Application No. 102024139196.0 filed Dec. 20, 2024, the disclosure of which is hereby incorporated by reference in its entirety.

### BACKGROUND OF THE INVENTION

### Field of the Invention

The invention relates to a fitting and a thread seal for establishing a fluid-tight screw connection for a pipe having an external thread.

The technical field relevant to the present invention is the on-site installation of piping systems, in which a piping system consisting of pipe sections and fittings is generally installed for conveying and guiding a fluid, i.e., a liquid or a gas. A fitting is generally understood to be a connecting piece for a pipeline, and a fitting is most commonly used to connect two or more pipe sections. The fitting therefore preferably has two or more press sections, for example in the form of press sleeves. The most common fittings include straight connectors, direction changes in the form of pipe bends, reducers, branches such as T-pieces, or crossings. However, a fitting is also understood to mean a pipe connection of a tap or another component. For example, thermometers or manometers as fittings have only one connection for a pipe section. Thus, the fitting of a tap has only one press section in order to connect a pipe section to the tap.

The piping systems described above are used in particular for the transport of drinking or heating water, of gas for operating a heating system, or of industrial gases. In principle, any fluid medium can be transported in the pipelines.

### Description of Related Art

Fittings are often designed as press connectors, in which the fitting and a pipe to be connected are joined by radial deformation. In certain applications, such as connections with predefined threads, fluid-tight screw connections are required as fittings in order to prevent the escape of liquids or gases from a closed system.

In the prior art, a connecting element is proposed whose external thread is coated with a polyamide layer. External threads with PTFE seals are widespread in sanitary and heating installations. These connectors have a section with a metallic external thread and a section in which a PTFE ring is positioned as a thread seal. This seal does not have a thread. During assembly, the counterpart cuts into the PTFE seal and thus seals against the internal thread. Other common means of sealing include hemp in combination with a thread sealing compound, PTFE tape, or other applied sealing agents.

Such thermoplastic sealing agents, such as polyamide, have a number of disadvantages, in particular the known sealing agents do not have permanent elasticity. The known sealing agents therefore become brittle over time and gradually lose their sealing properties. Higher temperatures or even greater temperature fluctuations, which alternately heat and cool the sealing agent, further promote embrittlement of the sealing agent and thus the occurrence of leaks.

In addition to the disadvantageous PTFE tapes, it is also known to apply sealing elements made of plastic, such as PTFE, to the external thread or the internal thread. During the screwing together of the threaded elements, the plastic seal provides sealing of the thread.

It is known from the prior art to provide, between the threaded section of the pipe section to be connected and the fitting, a one-piece or two-piece seal or thread seal with an internally formed threaded section. During installation, the fitting is pressed radially inwards and the seal or thread seal then seals permanently in the pressed state of the fitting and can at the same time compensate for thermally and/or mechanically induced changes in distance between the fitting and the pipe section. Such fittings are also referred to as threaded press connectors.

A requirement for such a threaded press connector is that the thread seal does not rotate, or rotates only minimally, relative to the fitting base body during screwing in of the pipe section, so that an effective screw connection is established between the fitting with the thread seal and the pipe section.

In the prior art, this problem has been addressed by ensuring that, after insertion of the thread seal into the fitting, it rests against the inside of the fitting with a sufficiently large contact force, so that the resulting static friction is sufficient to counteract the torque generated during screwing in of the pipe section.

The object of the present invention is therefore to provide a fitting and a thread seal for a fitting for establishing a fluid-tight screw connection for a pipe having an external thread, and a fitting itself, in which the disadvantages known from the prior art do not occur or at least occur to a lesser extent.

### SUMMARY OF THE INVENTION

The above-stated object is achieved according to the invention by means of a sealing element for a fitting for establishing a fluid-tight screw connection for a pipe having an external thread, comprising a fitting base body, a press sleeve connected to the fitting base body, a chamber formed in the press sleeve, a thread seal arranged in the chamber and having an internal thread, a first marking arranged on the press sleeve, and a second marking arranged on the thread seal, wherein the markings can be aligned relative to each other by rotation based on the same central axis of the internal thread of the thread seal and of the press sleeve.

The markings can then be brought into alignment in the azimuthal direction, i.e., in the rotational direction, during assembly of the thread seal within the press sleeve. In this way, a predefined angular position of the thread seal within the press sleeve is achieved by simple means.

By means of the markings, the so-called Poka-Yoke effect for error prevention can be achieved. This is a mechanism or technique intended to prevent human errors from occurring or leading to defects in a manufacturing or service process.

In a first advantageous embodiment, the first marking and the second marking are mechanically formed markings that at least partially correspond to each other. The mechanically formed marking may also be referred to as a geometric marking, since the geometry of the respective component is altered by the mechanical marking. The mechanically formed markings preferably produce a form fit when they are aligned with each other.

In this context, the the first marking and the second marking can preferably be designed as a marking in the form of a groove and a rib, or in the form of a moulding point. In particular, such a marking may be introduced into the press sleeve by milling. The thread seal may be designed with the mechanically formed marking in the form of a protruding element such as a cam.

This advantageously makes it possible for the first marking and the second marking to form a form fit and/or a force fit between the thread seal and the press sleeve. The markings then not only ensure correct azimuthal alignment of the thread seal and the press sleeve with respect to each other, but also provide anti-rotation protection when the pipe with the external thread is screwed into the thread seal.

A form fit may here be designed such that the contacting surfaces are sufficiently large to counteract the torque generated by screwing in an external thread. In the case of a force fit, the static friction must be greater than the torque generated when screwing in an external thread.

A mechanical or geometric marking also has the advantage that incorrect assembly and unintended rotation of the thread seal relative to the fitting base body or press sleeve can be largely prevented. This is because the thread seal can only be installed in a position in which the two mechanical or geometric features interlock or are in a defined orientation relative to each other.

A form-fit orientation of the thread seal relative to the press sleeve can also prevent incorrect insertion or rotation by the user.

In a further preferred embodiment, the first marking and the second marking are optical markings, and the first marking and the second marking are at least partially visible from the outside before the thread seal is installed in the press sleeve. This allows for simple assembly of the thread seal in the press sleeve, either during manufacturing or on site. Preferably, the first marking and the second marking are designed as a line or as a dot.

An optical marking is less expensive to produce than a mechanically formed marking.

The above-stated object is also achieved by a thread seal for a fitting of the type described above, comprising a seal body, an internal thread formed at least in sections, preferably extending continuously, on the inside of the seal body, and a marking.

The marking may be designed as an optical marking, preferably as a line or as a dot. The marking can also be designed as a mechanical marking, in particular in the form of a groove, a rib, or a moulding point.

This results in the same advantages as described above.

The above-stated object is also achieved by a fitting for establishing a fluid-tight screw connection for a pipe having an external thread, comprising a fitting base body, a press sleeve connected to the fitting base body, a chamber formed in the press sleeve, a thread seal arranged in the chamber and having an internal thread, and an internal thread section formed in the fitting base body at the proximal end of the press sleeve.

The combination of two internal threads has the advantage that the metal thread protects the adjacent sealing element from mechanical stress.

The markings provided can thus be aligned with each other in a predefined position during assembly in order to produce an approximately continuous thread pitch from the thread seal and the internal thread section in the fitting base body. In this case, the markings are aligned relative to each other by rotation based on the same central axis of the threads.

In such fittings for establishing a fluid-tight screw connection for a pipe having an external thread, which can also be referred to as threaded press connectors, the fitting itself has a portion of the internal thread in order to increase the connection strength. Thus, the seal and the fitting together form the internal thread into which the pipe provided with an external thread can be screwed. For this purpose, a thread section is formed in the fitting base body adjacent to the press sleeve. Here, there is the additional requirement that the threads of the fitting-side thread section and the seal-side thread are aligned with each other so that the pipe to be connected, having an external thread, can be screwed continuously into both thread sections.

Continuity of the internal threads can be ensured in particular by arranging the thread seal in the press sleeve in such a way that the internal thread section and the internal thread of the thread seal are co-rotating, in particular arranged so that the internal thread section and the internal thread of the thread seal form a continuous thread pitch.

For this purpose, the thread seal is in particular aligned with respect to the press sleeve in the azimuthal direction, i.e., with respect to its rotational position relative to the central axis of the internal thread, in such a way that the internal thread section and the internal thread of the thread seal form a continuous thread pitch.

Preferably, the thread seal and the press sleeve are fixed relative to each other with regard to their rotational position relative to the central axis of the internal thread (i.e., in the azimuthal direction), in particular by form fit and/or material closure. In this way, the alignment of the internal thread of the thread seal with the internal thread section can in particular be carried out and fixed at the factory, so that this alignment is maintained during subsequent assembly and alignment of the thread seal and internal thread section at the time of installation is unnecessary.

For a form-fit fixation of the thread seal and the press sleeve in the azimuthal direction, the thread seal and the press sleeve can in particular have one or more interlocking form-fit elements in the azimuthal direction, for example one or more recesses and one or more corresponding projections, which prevent rotation of the thread seal relative to the press sleeve. For a material closure fixation, the thread seal and the press sleeve can, for example, be bonded to each other.

If the thread seal and the press sleeve are fixed relative to each other with regard to their rotational position relative to the central axis of the internal thread (i.e., in the azimuthal direction), the markings can also be omitted. However, it is also conceivable that the first and second markings are nevertheless provided, for example to facilitate factory alignment of the internal thread with the internal thread section. Furthermore, it is conceivable that the markings themselves provide the form-fit fixation. However, form-fit elements independent of the markings can also be provided.

The thread seal and the fitting can furthermore also be designed as described above. The advantages of simplified assembly, improved alignment, and, where applicable, improved anti-rotation protection are also achieved in this case.

The thread seal can be made of numerous materials. Preferably, the seal body consists at least partially of one of the following materials: polytetrafluoroethylene (PTFE), ethylene propylene diene rubber (EPDM), fluororubber (FKM), hydrogenated acrylonitrile butadiene rubber (HNBR), high-density polyethylene (HDPE), chlorobutyl rubber (CIIR), polyamides (PA), polyhydroxybutyric acid (PBH), polybutadiene (butadiene rubber, PBR), and polyether ether ketone (PEEK).

The monolithic sealing element is therefore preferably made of an elastomer. Manufacture from another plastic, such as a thermoplastic, is also conceivable. The selected material should not have excessively high strength and, if it can be described by a modulus of elasticity, should have a modulus of elasticity of less than 5500 MPa, preferably less than 1500 MPa.

The material or materials selected must in principle be capable of achieving a surface pressure and maintaining it by means of spring-elastic properties that is higher than the prevailing internal system pressure.

The fitting, on the other hand, preferably consists of a metal or a metal alloy.

### BRIEF DESCRIPTION OF THE DRAWINGS

The invention will be explained below by way of exemplary embodiments with reference to the drawings. In the drawings

FIG. 1 shows, in an exploded view, a first exemplary embodiment of a fitting and a thread seal with mechanically formed markings together with a pipe having an external thread,

FIG. 2 shows the exemplary embodiment illustrated in FIG. 1 in the assembled state with a detailed enlargement of the markings,

FIG. 3 shows the thread seal illustrated in FIGS. 1 and 2 in a perspective view,

FIG. 4 shows the thread seal illustrated in FIGS. 1 and 2 in cross-section,

FIG. 5 shows the fitting illustrated in FIGS. 1 and 2 with the inserted thread seal in cross-section,

FIG. 6 shows a thread seal with an optical marking in a perspective view,

FIG. 7 shows a fitting with an optical marking in a perspective view,

FIG. 8 shows the thread seal according to FIG. 6 and the fitting according to FIG. 7 in the assembled state,

FIG. 9 shows the fitting with the thread seal according to FIG. 1 in a sectional view before screwing in the pipe,

FIG. 10 shows the fitting according to FIG. 9 with the pipe screwed in and with a press jaw applied,

FIG. 11 shows the fitting according to FIG. 10 in a schematic cross-sectional view before pressing,

FIG. 12 shows the fitting according to FIG. 11 after pressing, and

FIG. 13 shows a further exemplary embodiment of a fitting and a thread seal with mechanically formed markings together with a pipe having an external thread in an exploded view.

### DESCRIPTION OF THE INVENTION

In the following description of the various exemplary embodiments according to the invention, components and elements having the same function and mode of operation are provided with the same reference numerals, even if the components and elements may differ in dimension or shape in the various embodiments.

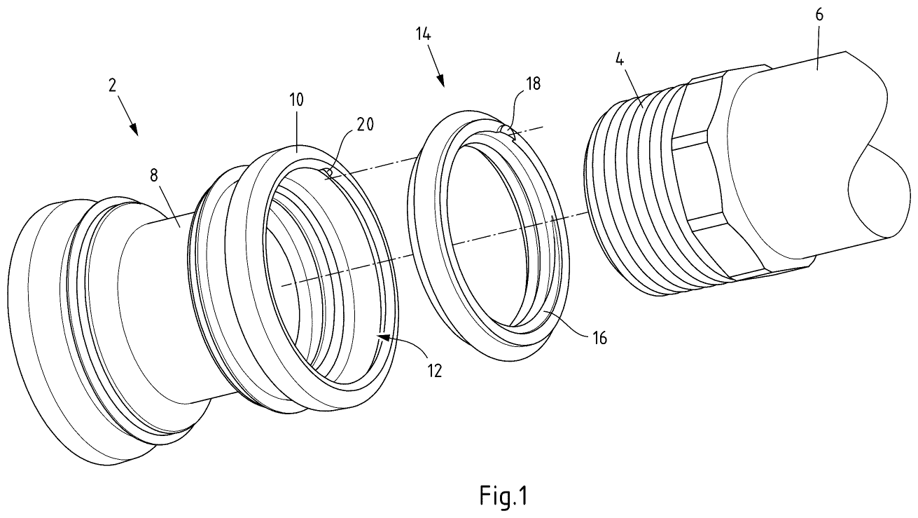

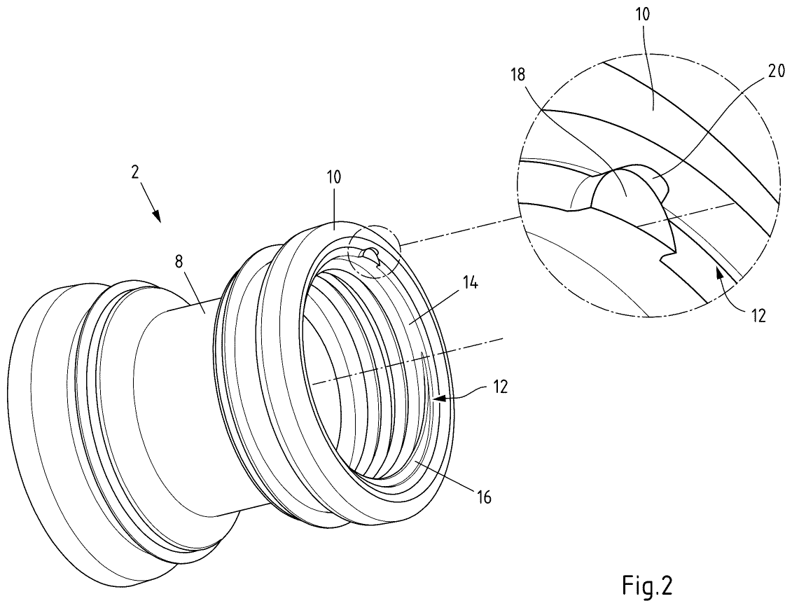

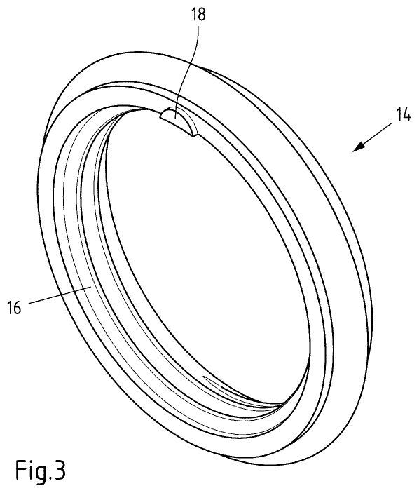

FIGS. 1 to 5 show a first exemplary embodiment of a fitting 2 according to the invention for establishing a fluid-tight screw connection for a pipe 6 having an external thread 4. A fitting base body 8 is provided, to which a press sleeve 10 is connected. A chamber 12 is formed in the press sleeve 10, in which a thread seal 14 is arranged, which in turn has an internal thread 16.

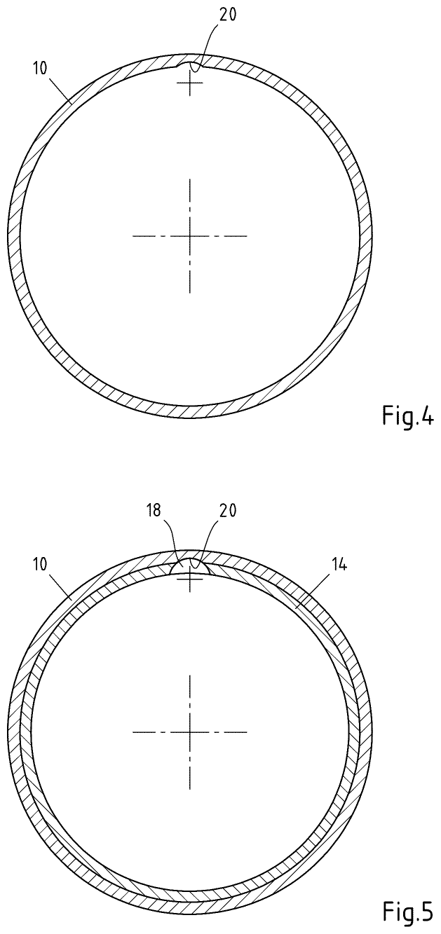

A first marking 18 is formed on the press sleeve 10, and a second marking 20 is formed on the thread seal 14. The markings 18 and 20 can be aligned relative to each other by rotation based on the same central axis-shown as a central cross in FIGS. 4 and 5—of the press sleeve 10 and the internal thread 16 of the thread seal 14. Therefore, the markings 18 and 20 can be brought into alignment in the azimuthal direction, i.e., in the rotational direction, during assembly of the thread seal 14.

In this exemplary embodiment, the first marking 18 and the second marking 20 are mechanically formed markings that at least partially correspond to each other. The marking 18 on the thread seal 14 is a partially circular element which, in the assembled state, partially engages in the recess 20, which is designed as a round recess. This results in a form fit between the two markings 18 and 20, which ensures the correct azimuthal alignment of the press sleeve 10 and the thread seal 14 with respect to each other and prevents rotation—at least up to a maximum force. Thus, a force fit is also realized.

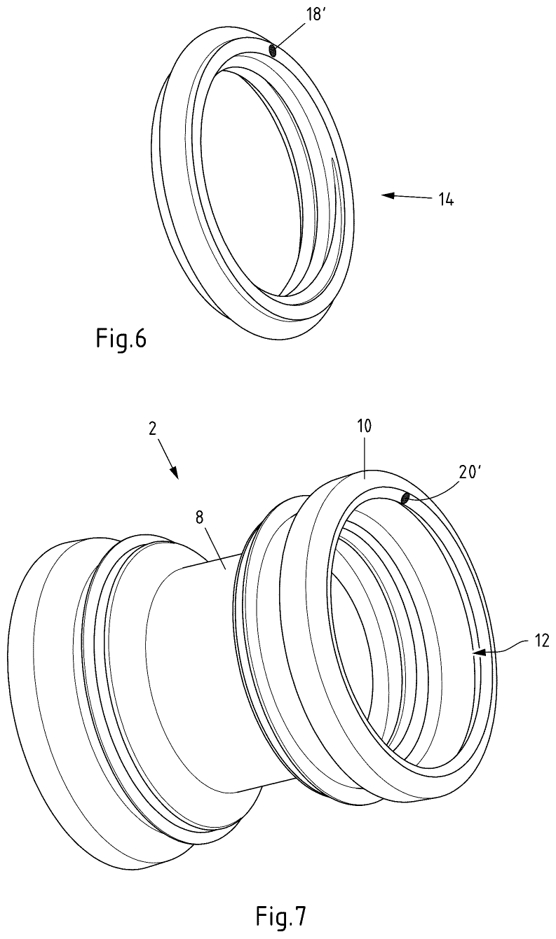

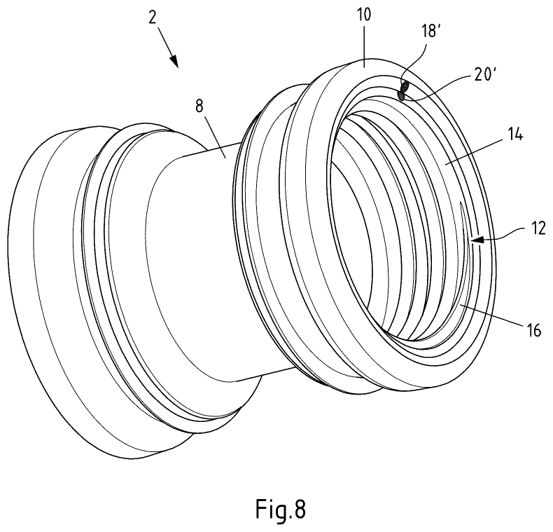

FIGS. 6 to 8 show an exemplary embodiment of a fitting 2 with a thread seal 14 having substantially the same design as previously described with reference to FIGS. 1 to 5. Here, in contrast to the first embodiment, the first marking 18′ and the second marking 20′ are optical markings, with the first marking 18′ and the second marking 20′ being at least partially visible from the outside before the thread seal 14 is installed in the press sleeve 10. The first marking 18′and the second marking 20′ are designed as a dot.

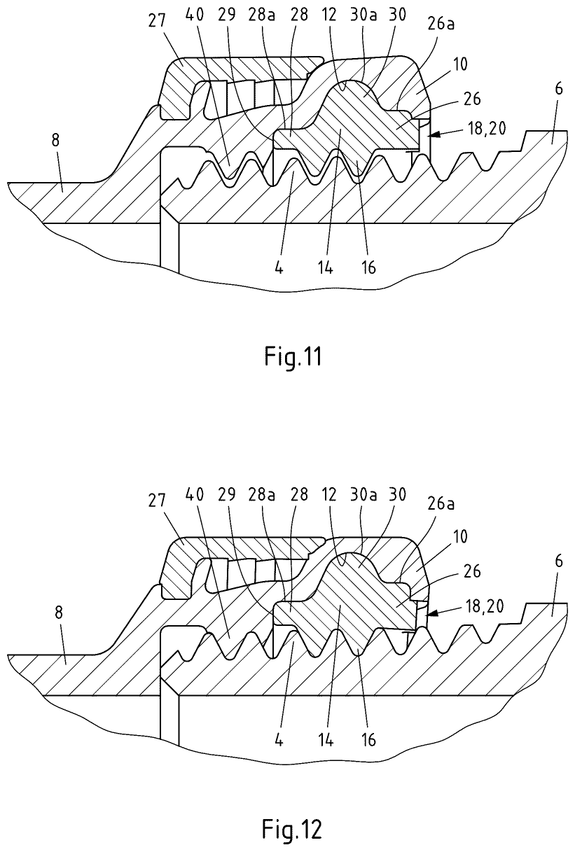

As can be seen in particular from FIGS. 11 and 12, the thread seal 14 has a seal body 24 with a distal end section 26 with respect to the arrangement in the fitting 2, with a proximal end section 28 with respect to the arrangement in the fitting, and with a middle section 30 arranged between the distal end section 26 and the proximal end section 28.

The internal thread 16 of the seal body 24 extends continuously over the distal end section 26, the middle section 30, and the proximal end section 28. The outer contour 30a of the middle section 30 projects radially beyond the outer contour 26a of the distal end section 26 and the outer contour 28a of the proximal end section 28. In addition, the seal body 24 is of monolithic design.

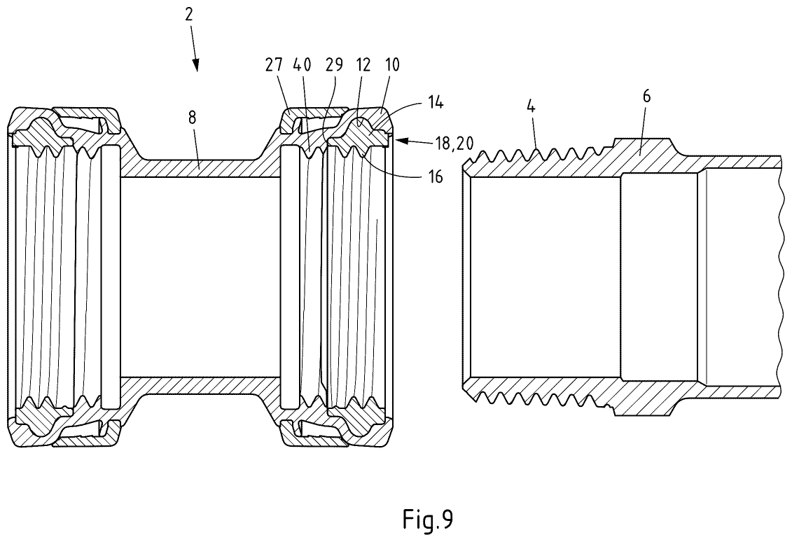

FIGS. 9 to 12 show a fitting 2 for establishing a fluid-tight screw connection for a pipe 6 having an external thread 4. As already described, a fitting base body 8 and a press sleeve 10, connected to the fitting base body 8, with a chamber 12 formed therein are provided. A thread seal 14 is arranged in the chamber 12, which has an internal thread 16.

Furthermore, in this exemplary embodiment, an internal thread section 40 is formed in the fitting base body 8 at the proximal end of the press sleeve 10. The thread seal 14 is also arranged in the press sleeve 10 in such a way that the internal thread section 40 and the internal thread 16 of the thread seal 14 are co-rotating, in particular form a continuous thread pitch.

For the described co-rotation, it is advantageous if the thread seal 14 is arranged in the press sleeve 10 with the aid of the first marking 18 or 18′and the second marking 20 or 20′in such a way that the internal thread 16 of the thread seal 14 and the internal thread section 40 of the fitting base body 8 are aligned with each other.

The rotational angle of the inserted thread seal 14 with respect to the fitting base body 8 is specified by the markings 18 or 18′ and 20 or 20′, respectively, in such a way that co-rotation of the two thread sections 16 and 40 is achieved and maintained. In this context, the thread sections 16 and 40 are co-rotating if the distance between all thread crests is an n-fold multiple of the thread pitch. In this way, the thread sections 16 and 40 in particular form a continuous thread pitch.

Additionally or alternatively to the markings 18 and 20 or 18′and 20′, respectively, the thread seal 14 and the press sleeve 10 may also have separate, mutually corresponding form-fit elements that define the azimuthal alignment of the thread seal 14 relative to the press sleeve 10, i.e., the rotational angle of the thread seal 14. For example, the mutually corresponding form-fit elements can be formed by the outer contour 30a of the middle section 30 and the corresponding inner contour of the chamber 12, by providing mutually corresponding recesses and projections in the azimuthal direction, which prevent rotation of the thread seal 14 relative to the press sleeve 10 by form fit.

Furthermore, the thread seal 14 can be adhesively bonded into the press sleeve 10 during manufacture, thereby fixing the azimuthal alignment of the thread seal 14 relative to the press sleeve 10.

As can be seen from FIGS. 9 to 12, a guide element 27, spaced from the chamber 12 and projecting radially outward, is formed at the proximal end of the press sleeve 10 in the form of a separate part connected to the press sleeve 10. The guide element 27 essentially serves to allow a press jaw of a pressing tool to be applied more easily and accurately.

The outer side of the press sleeve 10 has, at the distal end of the chamber 12, a diameter corresponding to the outer diameter of the projecting guide element 27. Overall, this results in an asymmetrical contour of the press sleeve 10.

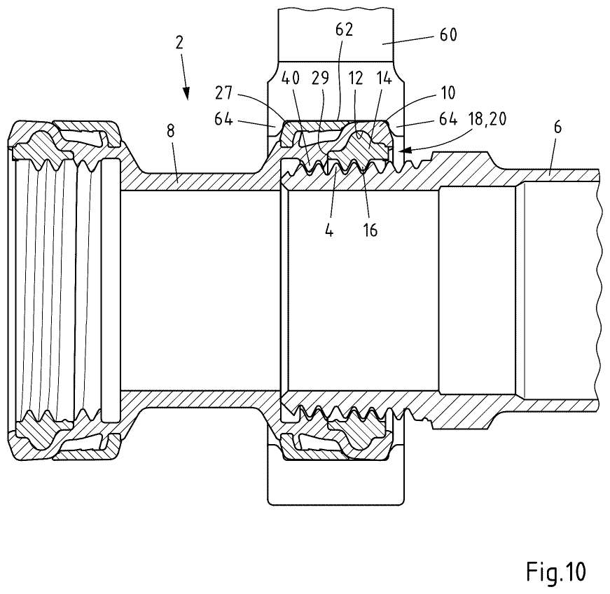

FIG. 10 shows the fitting 2 with the pipe 6 screwed in, in the unpressed state, and with a press jaw 60 applied, which has an essentially cylindrical pressing contour 62. Only at two positions of the circumferential pressing contour 62 are radially inwardly projecting sections 64 formed, which engage with the press sleeve 12 in each case outside the chamber 10 and the guide element 27. The projecting sections 64, also referred to as guide cams, result in a lower pressing force than a circumferential guide rib, which would guide the fitting 2 during forming.

FIGS. 11 and 12 show the fitting 2 before and after pressing in a schematic representation. The cylindrical pressing contour 62 deforms the press sleeve 10 during the radial inward pressing process, i.e., the distal end of the chamber 12 as well as the guide element 27, resulting primarily in bending of the press sleeve 10. This bending is also referred to as folding in the context of this description. Thus, the press sleeve 10 has a geometry that folds over on one side. In addition, the guide element 27 bends inward.

By folding the press sleeve 10, the sealing element 2 is pressed firmly onto the pipe 6 and the thread section 4 by the chamber 12, which is radially deformed inward. As a result, a section several thread turns long, comprising the thread sections 4, 16, and 40, is formed along which the sealing element 2 is sealingly connected to the pipe 6.

The pressing forces and degree of deformation can be specifically adjusted by the one-sided folding geometry of the press sleeve 10. By reducing the size of the area of the press sleeve 10 to be deformed, the pressing forces are reduced and wall thicknesses can nevertheless be maintained.

The fitting 2 is made, for example, of silicon bronze, but can be made of any other metal or alloy. The fitting 2 is screwed onto an external thread according to DIN EN 10226 or ISO 228 and then pressed.

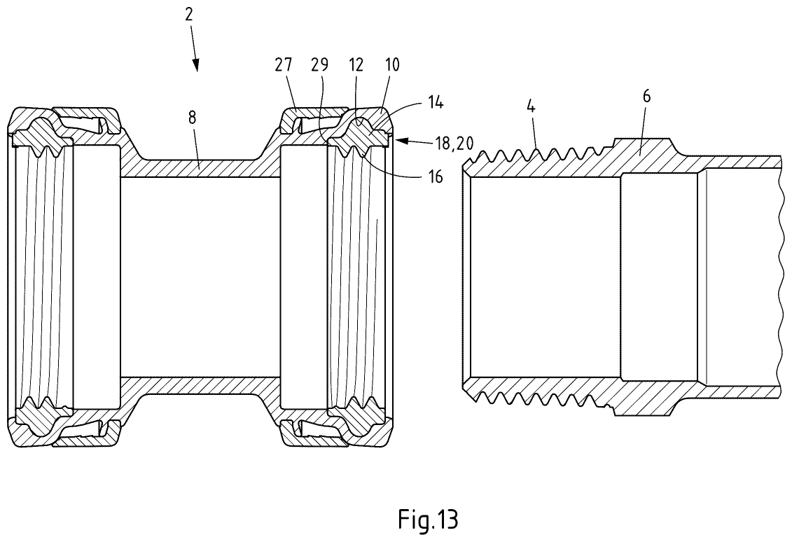

FIG. 13 finally shows an exemplary embodiment in which, in contrast to the previously explained exemplary embodiment, the fitting base body 8 does not have an internal thread section, and screwing the pipe 6 into the fitting 2 takes place only via the thread seal 14 with thread 16.

1. Fitting for establishing a fluid-tight screw connection for a pipe (6) having an external thread (4),
with a fitting base body (8),
with a press sleeve (10) connected to the fitting base body (8),
with a chamber (12) formed in the press sleeve (10),
with a thread seal (14) arranged in the chamber (12) and having an internal thread (16)
with a first marking (18, 18′) arranged on the press sleeve (10) and
with a second marking (20, 20′) arranged on the thread seal (14),
wherein the markings (18, 18′; 20, 20′) can be aligned relative to each other by rotation based on the same central axis of the internal thread (16) of the thread seal (14) and of the press sleeve (10).

2. Fitting according to claim 1,
characterised
in that the first marking (18) and the second marking (20) are mechanically formed markings that at least partially correspond to each other.

3. Fitting according to claim 2,
characterised
in that the first marking (18) and the second marking (20) are designed a marking
in the form of a groove and a rib or in the form of a moulding point.

4. Fitting according to claim 2 or 3,
characterised
in that the first marking (18) and the second marking (20) form a form fit and/or a force fit between the thread seal (14) and the press sleeve (10).

5. Fitting according to claim 1,
characterised
in that the first marking (18′) and the second marking (20′) are optical markings and
in that the first marking (18′) and the second marking (20′) are at least partially visible from the outside before the thread seal (14) is installed in the press sleeve (10).

6. Fitting according to claim 5,
characterised
in that the first marking (18′) and the second marking (20′) are designed as a line or a dot.

7. Fitting according to any one of claims 1 to 6, characterised
in that the fitting base body (8) has an internal thread section (40) at the proximal end of the press sleeve (10) and
in that the thread seal (14) is arranged in the press sleeve (10) with the aid of the first marking (18, 18′) and the second marking (20, 20′) in such a way that the internal thread (16) of the thread seal (14) and the internal thread section (40) of the press sleeve (10) are co-rotating.

8. Thread seal for a fitting according to any one of claims 1 to 7,
with a seal body (24),
with an internal thread (16) formed at least in sections, preferably extending continuously, on the inside of the sealing body (24) and
with a marking (18, 18′).

9. Thread seal according to claim 8,
characterised
in that the marking (18) is designed as a mechanical marking, in particular in the form of a groove, a rib or a moulding point.

10. Thread seal according to claim 8,
characterised
in that the marking (20) is designed as an optical marking, preferably as a line or as a dot.

11. Fitting for establishing a fluid-tight screw connection for a pipe (6) having an external thread (4),
with a fitting base body (8),
with a press sleeve (10) connected to the fitting base body (8),
with a chamber (12) formed in the press sleeve (10),
with a thread seal (14) arranged in the chamber (10) and having an internal thread (16), and
with an internal thread section (40) formed in the fitting base body (8) at the proximal end of the press sleeve (10).

12. Fitting according to claim 11,
characterised
in that the thread seal (14) is arranged in the press sleeve (10) in such a way that the internal thread section (40) and the internal thread (16) of the thread seal (14) are co-rotating, in particular form a continuous thread pitch.

13. Fitting according to claim 11 or 12,
characterised
in that the thread seal (14) and the press sleeve (10) are fixed in relation to each other with regard to their rotational position relative to the centre axis of the internal thread, preferably by form fit and/or material closure.

14. Fitting according to one of claims 11 to 13,
characterised
in that the thread seal is designed according to one of claims 8 to 10.
